(19) United States
(12) Patent Application Publication
(10) Pub. No.: US 2026/0184645 A1
(43) Pub. Date: Jul. 2, 2026

(54) Repair Method For Reinforced Concrete

(71) Applicant: JDC Corporation, Minato-ku, Tokyo (JP)

(72) Inventors: Takeo Asakura, Tokyo (JP); Mutsuhiro Ohno, Tokyo (JP); Masakazu Sekiguchi, Minato-ku, Tokyo (JP)

(21) Appl. No.: 19/122,944

(22) PCT Filed: Dec. 18, 2023
(86) PCT No.: PCT/JP2023/045193

§ 371 Date: Mar. 19, 2026

Related U.S. Application Data
(60) Provisional application No. 63/490,823, filed on Mar. 17, 2023.

(51) Int. Cl. C04B 41/65; C04B 41/63; C04B 41/72; C04B 103/61; C04B 111/26; C04B 111/72

(52) U.S. Cl. CPC C04B 41/65; C04B 41/63; C04B 41/72; C04B 2103/61; C04B 2111/26; C04B 2111/723

(57) ABSTRACT

In order to prevent corrosion of reinforced concrete, a repair method for reinforced concrete includes a step of injecting a repairing agent containing a layered double hydroxide represented by a layered double hydroxide having a chemical formula represented by M²⁺₁₋ₓM³⁺ₓ(OH)₂(NO₃⁻)_{x/n}·mH₂O (M²⁺ represents a divalent metal, M³⁺ represents a trivalent metal, and n is a natural number) into concrete from a void on a surface of reinforced concrete, and a step of applying the repairing agent containing the layered double hydroxide to the concrete.

### TECHNICAL FIELD

The present invention relates to a repair method for reinforced concrete.

### BACKGROUND

Reinforced concrete is a structure in which reinforcing bars having a high tensile strength and concrete having a high compressive strength are used in combination. The reinforcing bar is easily oxidized to generate rust, but a passive film is formed on the surface of the reinforcing bar by highly alkaline cement contained in concrete. Therefore, the reinforcing bar inside the concrete does not corrode, and it is possible to continue to satisfy the required performance.

However, there has been a problem that durability of concrete is lowered by neutralization with carbon dioxide. To prevent neutralization of concrete, it has been proposed to form an undercoat film, an intermediate coat film, and a top coat film on the surface of concrete (see, for example, JP Patent Publication No. 2011-20891 A).

Further, when a crack or the like occurs on the surface of concrete, a vicious cycle in which oxygen, moisture, or the like enters from the cracked portion, and further rust is generated occurs. Therefore, to prevent deterioration of reinforced concrete, a resinous coating material is applied to the concrete surface (see, for example, JP Patent Publication No. 2014-83530 A).

### SUMMARY

Forming three different layers on the surface of concrete has left room for improvement in terms of time and cost.

When a reinforcing bar is corroded due to salt damage, concrete covering the corroded reinforcing bar is sometimes chipped to expose the reinforcing bar, and a rust inhibitor is applied to the surface of the reinforcing bar. As the rust inhibitor, for example, one containing nitrite ions (NO₂⁻) is known. When this type of rust inhibitor is used, a passive film (Fe₂O₃) is generated by a reaction between nitrite ions (NO₂⁻) and iron ions (Fe²⁺) to prevent corrosion of the reinforcing bar.

However, because nitrite ions (NO₂⁻) are used in an aqueous solution, there is a risk of exposure to the human body and environmental load (leakage).

An object of the present invention is to provide a repair method for reinforced concrete capable of efficiently preventing corrosion of reinforced concrete.

A repair method for reinforced concrete includes a step of injecting a repairing agent containing a layered double hydroxide represented by a chemical formula M²⁺₁₋ₓM³⁺ₓ(OH)₂(NO₃⁻)_{x/n}·mH₂O into concrete from a void on a surface of reinforced concrete, and a step of applying the repairing agent containing the layered double hydroxide to the concrete. In the formula, M²⁺ represents a divalent metal, M³⁺ represents a trivalent metal, and n is a natural number.

According to the present invention, it is possible to efficiently repair reinforced concrete.

### BRIEF DESCRIPTION OF THE DRAWINGS

FIGS. 1A to 1D are diagrams for explaining a rust prevention method according to an embodiment.

FIGS. 2A to 2C are diagrams for explaining the action of a nitrate-type layered double hydroxide.

FIGS. 3A to 3D are diagrams for explaining an example of an experiment for checking the rust prevention action of a repairing agent.

FIG. 4 is a diagram illustrating a state in which a repairing agent is injected into concrete from a void such as a crack on a concrete surface.

FIG. 5 is a diagram illustrating the results of X-ray diffraction obtained with an X-ray diffractometer.

### DETAILED DESCRIPTION

Hereinafter, a rust prevention method for a steel material according to an embodiment will be described.

### Regarding Repairing Agent

First, a repairing agent used in the present embodiment will be described. The repairing agent of the present embodiment contains a resin having a function as a binder material and a layered double hydroxide. Alternatively, a layered double hydroxide may be mixed with a coating material containing a resin to form a repairing agent, or a layered double hydroxide may be mixed with a coating material containing no resin to form a repairing agent.

### Resin

The resin is a resin that can cover the surface of concrete or a reinforcing bar and need only be a curable liquid resin that can prevent external moisture, chlorine, or the like from contacting the covered surface. As the resin, for example, an epoxy-based resin, an acrylic resin, a urethane-based resin, or the like can be used. These resins may be used alone or two or more types thereof may be used in combination. The resin may be a one-component resin or a two-component resin.

### Epoxy-Based Resin

As the epoxy-based resin, for example, a bisphenol A type epoxy resin, a halogenated bisphenol A type epoxy resin, a bisphenol F type epoxy resin, a novolac type epoxy resin, a cresol novolac type epoxy resin, or the like can be used.

Examples of the bisphenol A type epoxy resin include polycondensates of bisphenol A type diglycidyl ethers such as bisphenol A diglycidyl ether, bisphenol A polypropylene oxide diglycidyl ether, bisphenol A ethylene oxide diglycidyl ether, hydrogenated bisphenol A diglycidyl ether, and hydrogenated bisphenol A propylene oxide diglycidyl ether. One type of such epoxy resins can be used or two or more types thereof can be used in combination.

A reactive diluent can also be added to and blended with the epoxy-based resin. Such a reactive diluent is effective in reducing the viscosity of the composition. As such a reactive diluent, a compound having one epoxy group in a molecule, such as phenyl glycidyl ether, butyl glycidyl ether, allyl glycidyl ether, styrene oxide, or octylene oxide, can be used. Such a reactive diluent can also be blended in an amount of preferably 45 wt % or less, and preferably 25 wt % or less per main agent.

In the epoxy-based resin, a compound that does not have an epoxy group but can react with a component (such as an amine compound) of a curing agent can also be blended as an additive. As such a compound, an isocyanate such as hexamethylene diisocyanate or tolylene diisocyanate, and further an α,β-unsaturated carbonyl compound that undergoes a Michael addition reaction with an amine compound, for example, an acrylic acid ester or an acrylamide derivative can be used. The acrylic acid ester is effective in improving low-temperature curability, and the acrylamide derivative is effective in improving thixotropy or improving adhesiveness. Such an additive can be blended in a range of preferably 30 wt % or less, and more preferably 20 wt % or less per main agent.

In the epoxy resin, as other components, a plasticizer, a dye, an organic pigment, an inorganic filler, a polymer compound, an antioxidant, an ultraviolet absorber, a coupling agent, a surfactant, or the like can also be appropriately blended.

### Acrylic Resin

As the acrylic resin, for example, a polymer of an acrylic monomer or a copolymer of an acrylic monomer and another monomer can be used. Examples of the acrylic monomer include (meth)acrylic acid, C1-10 alkyl esters of (meth)acrylic acid such as methyl (meth)acrylate, ethyl (meth)acrylate, propyl (meth)acrylate, butyl (meth)acrylate, t-butyl (meth)acrylate, and hexyl (meth)acrylate, C3-12 cycloalkyl esters of (meth)acrylic acid such as cyclohexyl (meth)acrylate, aryl esters of (meth)acrylic acid such as phenyl (meth)acrylate, aralkyl esters of (meth)acrylic acid such as benzyl (meth)acrylate, hydroxy C2-6 alkyl (meth)acrylates such as 2-hydroxyethyl (meth)acrylate and 3-hydroxypropyl (meth)acrylate, alkylamino-alkyl (meth)acrylates such as dimethylaminoethyl (meth)acrylate, diethylaminoethyl (meth)acrylate, and diethylaminopropyl (meth)acrylate, (meth)acrylamides or derivatives thereof such as (meth)acrylamide, N-methyl (meth)acrylamide, methylol (meth)acrylamide, and alkoxymethyl (meth)acrylamide, epoxy group-containing (meth)acrylates such as glycidyl (meth)acrylate, and (meth)acrylonitrile.

Examples of the monomer copolymerized with the acrylic monomer include aromatic vinyl-based monomers such as styrene, α-methylstyrene, p-t-butylstyrene, and vinyltoluene, fatty acid vinyl ester-based monomers such as vinyl propionate, esters of unsaturated polycarboxylic acids such as maleic anhydride, maleic acid, fumaric acid, and itaconic acid or unsaturated polycarboxylic acid derivatives such as dimethyl maleate and diethyl fumarate, N-substituted maleimides such as N-phenylmaleimide, and olefinic monomers such as ethylene and propylene. These monomers may be used alone, or two or more types thereof may be used in combination.

### Urethane-Based Resin

As the urethane-based resin, for example, a urethane prepolymer having a free isocyanate group obtained by allowing a polyol and a polyisocyanate to react with each other can be used.

As the polyol, polyether polyol, polyolefin polyol, or the like can be used.

As the polyether polyol, it is appropriate to use a polyalkylene polyol having 2 to 4 hydroxy groups (active hydrogen groups) in a molecule obtained by addition polymerization of, preferably, an alkylene oxide having 2 to 8 carbon atoms such as ethylene oxide, propylene oxide, butylene oxide, or tetrahydrofuran to a polyol having 2 to 8 carbon atoms and having 2 or more, preferably 2 to 6 hydroxy groups such as ethylene glycol, propylene glycol, butanediol, diethylene glycol, glycerin, hexanediol, hexanetriol, glycerin, trimethylolpropane, or pentaerythritol in the presence of an alkali catalyst or the like.

As the polyolefin polyol, for example, it is appropriate to use a polydiene polyol having 2 to 4 hydroxy groups in a molecule obtained by addition polymerization of an alkylene oxide such as ethylene oxide, propylene oxide, butylene oxide, or tetrahydrofuran to a diene-based compound such as butadiene or isoprene. As the polyisocyanate, a compound having 2 or more, preferably 2 or 3, isocyanate groups in one molecule is appropriate.

Specific examples of the polyisocyanate include isocyanate compounds such as 2,4-toluene diisocyanate, 2,6-toluene diisocyanate, 4,4′-diphenylmethane diisocyanate, 2,4′-diphenylmethane diphenyl diisocyanate, carbodiimide-modified diphenylmethane diisocyanate, hexamethylene diisocyanate, xylylene diisocyanate, metaxylylene diisocyanate, 1,5-naphthalene diisocyanate, hydrogenated diphenylmethane diisocyanate, hydrogenated toluylene diisocyanate, hydrogenated xylylene diisocyanate, and isophorone diisocyanate; biuret polyisocyanate compounds such as Sumidur N (trade name, manufactured by Sumitomo Bayer Urethane Co., Ltd.); polyisocyanate compounds having an isocyanate ring such as Desmodur IL, HL (trade name, manufactured by Bayer AG) and Coronate E.H. (trade name, manufactured by Nippon Polyurethane Industry Co., Ltd.); adduct polyisocyanate compounds such as Sumidur L (trade name, manufactured by Sumitomo Bayer Urethane Co., Ltd.) and Coronate HL (trade name, manufactured by Nippon Polyurethane Industry Co., Ltd.). One type of these polyisocyanates can be used alone, or two or more types thereof can be used as a mixture.

### Layered Double Hydroxide

The layered double hydroxide is one having a chemical formula represented by M²⁺₁₋ₓM^{3+x}(OH)₂(NO₃⁻)_{x/n}·mH₂O. Here, M²⁺ represents a divalent metal, M³⁺ represents a trivalent metal, and n is a natural number. In addition, x is a number in the range of 0<x<1 and is generally a number in the range of ⅙<x<⅓. Further, m is a number larger than 0. This layered double hydroxide is sometimes referred to as a hydrotalcite-like compound. Examples of the divalent metal ion (M²⁺) include Mg²⁺, Fe²⁺, Zn²⁺, Li²⁺, Ni²⁺, Co²⁺, and Cu²⁺. Examples of the trivalent metal ion (M³⁺) include Al³⁺, Fe³⁺, Cr³⁺, and Mn³⁺. The divalent metal ion (M²⁺) and the trivalent metal ion (M³⁺) included in the general formula need not be one type and may include a plurality of types.

Nitrate ions NO₃⁻ present between layers of the layered double hydroxide are exchanged for other anions having a higher affinity with the layered double hydroxide. The layered double hydroxide containing nitrate ions as in the present embodiment is referred to as a nitrate-type layered double hydroxide. When the nitrate-type layered double hydroxide adsorbs chloride ions (Cl⁻) from a reinforcing bar corroded due to salt damage, the nitrate-type layered double hydroxide releases nitrate ions NO₃⁻ instead. The released nitrate ions NO₃⁻ react with iron ions (Fe²⁺) to generate magnetite (Fe₃O₄), that is, black rust, according to the following reaction formula (1), thereby preventing corrosion of the reinforcing bar.

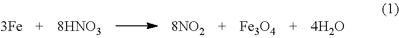

The layered double hydroxide according to the present embodiment can be Mg²⁺₁₋ₓAl³⁺ₓ(OH)₂(NO₃⁻)_{x/n}·mH₂O (Mg—Al type) in which the divalent metal ion (M²⁺) is Mg²⁺ and the trivalent metal ion (M³⁺) is Al³⁺, or Mg²⁺₁₋ₓFe³⁺ₓ(OH)₂(NO₃⁻)_{x/n}·mH₂O (Mg—Fe type) in which the divalent metal ion (M²⁺) is Mg²⁺ and the trivalent metal ion (M³⁺) is Fe³⁺, or Fe²⁺₁₋ₓFe³⁺ₓ(OH)₂(NO₃⁻)_{x/n}·mH₂O (Fe—Fe type) in which the divalent metal ion (M²⁺) is Fe²⁺ and the trivalent metal ion (M³⁺) is Fe³⁺. The Mg—Fe type is superior to the Mg—Al type in that the Mg—Fe type has a high specific gravity and is easy to separate by precipitation, and the raw material cost can be reduced.

The layered double hydroxide according to the present embodiment preferably has a crystallite size of 20 nm or less, more preferably 10 nm or less. For example, when the crystallite size of the layered double hydroxide is reduced to 20 nm or less, the specific surface area can be increased to 20 m²/g or more, and the adsorption performance can be improved.

The layered double hydroxide is synthesized by mixing an acidic solution containing a divalent metal ion and a trivalent metal ion with an alkaline solution. The layered double hydroxide synthesized here can have a larger specific surface area as the crystallite size is reduced. Therefore, it is preferable to shorten the aging time after synthesis, and it is preferable to neutralize at least within 120 minutes, preferably within 60 minutes, after mixing the acidic solution and the alkaline solution, and more preferably simultaneously with mixing. Details of the synthesis method for the layered double hydroxide are described in JP Patent Publication No. 2021-195276 A.

### Rust Prevention and Corrosion Prevention Method

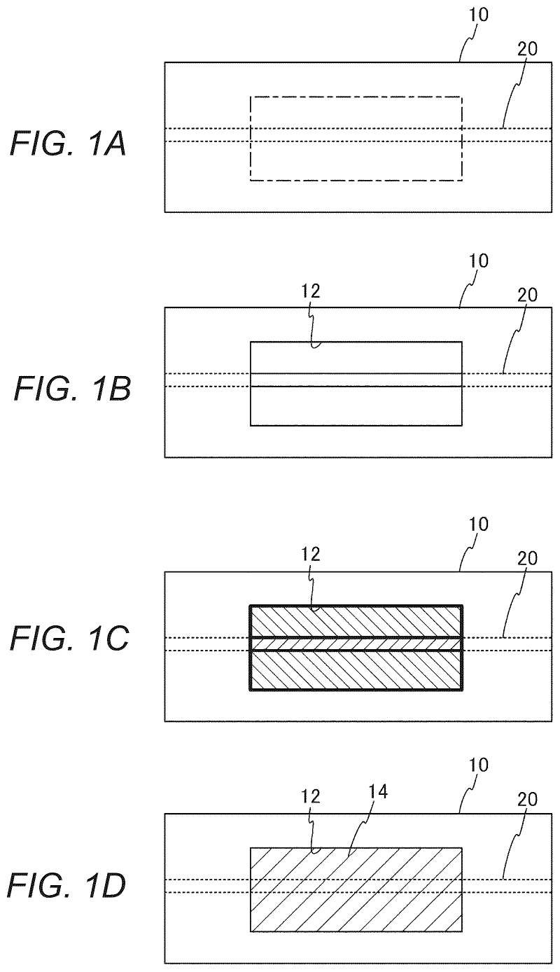

Next, with reference to FIGS. 1A to 1D, a repair method related to rust prevention and corrosion prevention of a concrete structure 10 when a reinforcing bar embedded in reinforced concrete (hereinafter referred to as a concrete structure) and concrete covering the reinforcing bar are affected by salt damage or the like will be described.

As illustrated in FIG. 1A, in a case where there is a concrete structure 10, it is assumed that a hammering test by an operator from outside reveals that a reinforcing bar 20 (a portion surrounded by a one-dot chain line) present inside the concrete structure 10 has been damaged by salt.

In this case, as illustrated in FIG. 1B, the operator chips a part of the concrete structure 10 (a portion damaged by salt) to expose the reinforcing bar 20 damaged by salt from the concrete structure 10 (see reference numeral 12 in FIG. 1B). At this time, the concrete is removed so that the back surface side of the reinforcing bar 20 is also exposed.

Subsequently, as illustrated in FIG. 1C, the operator directly applies the repairing agent (a repairing agent containing a resin and a nitrate-type layered double hydroxide) of the present embodiment to the reinforcing bar 20 exposed from the concrete structure 10 and a concrete surface (chipped surface) exposed by chipping the concrete structure 10.

After the repairing agent is applied, the operator waits until a predetermined timing between when the repairing agent starts to cure and when the repairing agent cures completely is reached, and at the predetermined timing, as illustrated in FIG. 1D, the operator uses a polymer cement mortar 14 to cover a chipped portion 12 and repairs the cross section. The predetermined timing is a timing when about one hour has elapsed after the repairing agent is applied, and the repairing agent is assumed to be in a sticky state (tacky state).

Here, when the resin contained in the repairing agent is a thermosetting resin, the time (waiting time) from when the repairing agent is applied to when the chipped portion 12 is covered with the polymer cement mortar 14 varies depending on the temperature at the site (the temperature around the reinforcing bar 20). When the temperature at the site is high, the waiting time becomes shorter, and when the temperature at the site is low, the waiting time becomes longer. Therefore, the operator may determine the waiting time based on the temperature at the site. Then, the operator may perform the treatment in FIG. 1D at the stage when the waiting time has elapsed.

In addition, in the present embodiment, the repairing agent prevents concrete from being corroded by carbon dioxide in the atmosphere entering from the surface of concrete, which is originally alkaline, to neutralize the inside of the concrete.

Specifically, when the operator applies the repairing agent to the surface of the concrete structure 10, the nitrate-type layered double hydroxide adsorbs carbon dioxide near the surface of the concrete structure 10. In addition, when the operator applies the repairing agent to the surface of the concrete structure 10, the resin prevents oxygen, moisture, and the like from entering from the concrete surface. In addition, because the repairing agent penetrates into the concrete structure 10 from minute cracks on the surface of the concrete structure 10, the repairing agent also adsorbs carbon dioxide inside the concrete structure 10 and prevents oxygen, moisture, and the like from entering.

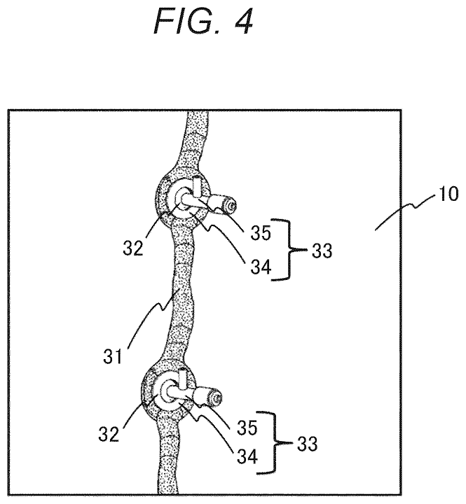

FIG. 4 is a diagram illustrating a state in which the repairing agent is injected into concrete from a void such as a crack on a concrete surface. A crack occurs, for example, when carbon dioxide in the atmosphere enters the inside of the concrete structure 10 and the inside of the concrete structure 10 expands and contracts. This crack may reach the reinforcing bar inside the concrete structure 10 and has a larger surface area and a deeper depth than the above-described crack.

A cracked portion of the concrete structure 10 is closed by applying a temporary fixing seal material 31 along the crack. The temporary fixing seal material 31 is not applied to the injection place 32 where the repairing agent is injected.

In FIG. 4, there are two injection places 32, but the injection place(s) can be arbitrarily provided according to the length of the crack.

An injection tool 33 is attached to the injection place 32 to inject the repairing agent. The injection tool 33 includes an attachment seat 34 and injection conduit 35. The attachment seat 34 is formed in a circular shape in the present embodiment and is bonded to the concrete structure 10. The above-described temporary fixing seal material 31 may be used as an adhesive of the attachment seat 34. By attaching a tank (not illustrated) into which the repairing agent is injected to the injection tool 33 to be connected to the injection conduit 35, the repairing agent can be injected from a cracked place toward the inside of the concrete structure 10.

The nitrate-type layered double hydroxide contained in the repairing agent adsorbs chloride ions (Cl⁻) adhering to the reinforcing bar 20 or adsorbs carbon dioxide inside the concrete structure 10, so that the reinforcing bar 20 can be prevented from rusting or neutralization of the concrete structure 10 can be prevented. In addition, when the repairing agent contains a resin, it is possible to prevent oxygen, moisture, and the like from entering the inside of the concrete structure 10. The injection of the repairing agent into the cracked place is preferably performed before the application of the repairing agent to the surface of the concrete structure 10. This is because if the repairing agent is applied to the surface of the concrete structure 10 first, the surface of the cracked place is covered with the repairing agent, and it becomes difficult to inject the repairing agent.

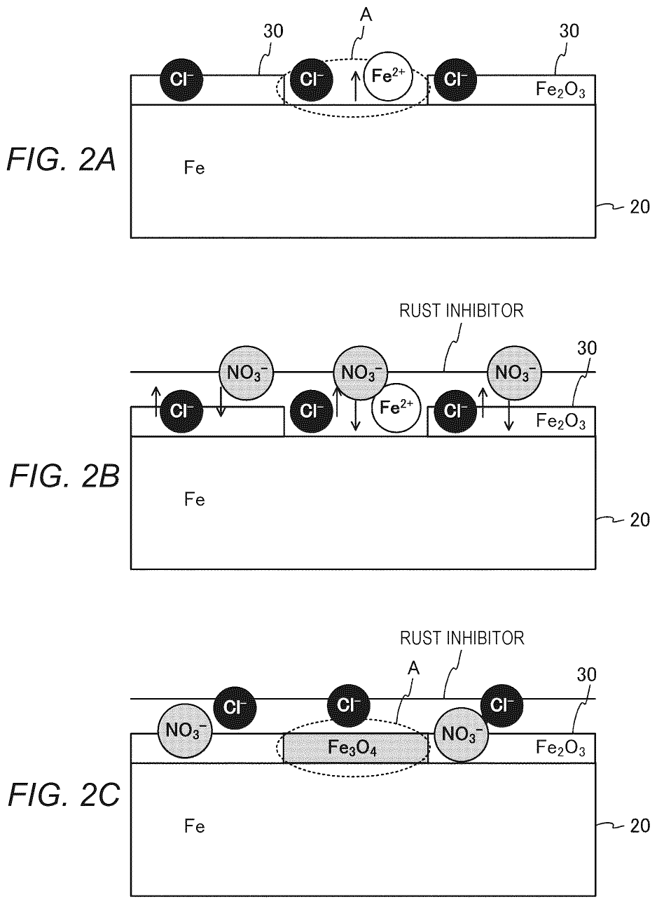

As described above, in the present embodiment, one containing a nitrate-type layered double hydroxide is used as the repairing agent. The action of the nitrate-type layered double hydroxide will be described with reference to FIGS. 2A to 2C.

FIG. 2A illustrates a state in which a part of the reinforcing bar 20 is corroded by chloride ions (Cl⁻). Usually, the surface of the reinforcing bar 20 in the concrete structure is covered with a passive film (Fe₂O₃) 30, and this effect prevents the occurrence of an oxidation reaction (corrosion). On the other hand, when the chloride ion concentration increases, the passive film disappears as indicated by the broken line ellipse A in FIG. 2A, and corrosion occurs.

When the repairing agent containing a nitrate-type layered double hydroxide is directly applied to the reinforcing bar 20 in a state where corrosion has occurred in a part of the reinforcing bar 20 as described above, as illustrated in FIG. 2B, the nitrate-type layered double hydroxide adsorbs chloride ions (Cl⁻) and releases nitrate ions (NO₃⁻) instead.

Due to the occurrence of the chemical reaction of the above reaction formula (1), magnetite (Fe₃O₄), that is, black rust is generated in a portion indicated by the broken line ellipse A in FIG. 2C. This makes it possible to prevent corrosion of the reinforcing bar. Here, it is important that the conditions for generation of magnetite (Fe₃O₄) by nitrate ions (NO₃⁻) are anaerobic environmental conditions and conditions (dry state) with as little H₂O as possible. In the present embodiment, because the repairing agent contains a resin as a binder material, the covered reinforcing bar surface after the repairing agent is applied becomes an anaerobic environment. In addition, because the resin does not contain moisture, the covered reinforcing bar surface becomes an environment with as little H₂O as possible. As described above, in the present embodiment, the condition that magnetite is easily generated is ensured in the portion covered with the repairing agent. In the present embodiment, it is preferable to make the surface of the reinforcing bar into a dry state (remove moisture) before the repairing agent is applied.

### Experimental Example

Hereinafter, an example of an experiment for checking the rust prevention action of the repair of the present embodiment will be described.

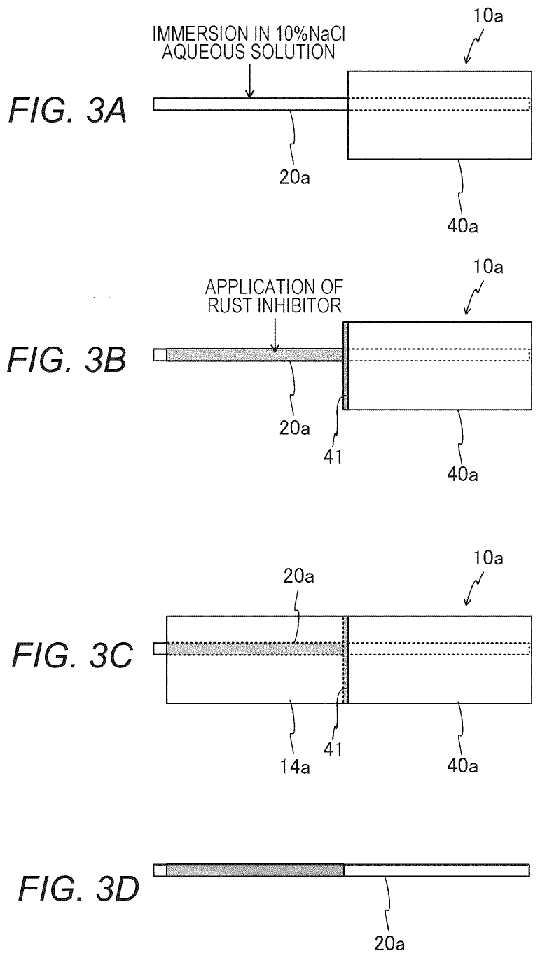

In this experiment, as illustrated in FIG. 3A, a sample 10a in which a part of a D13 (diameter: about 13 mm) deformed reinforcing bar 20a was covered with concrete 40a was prepared. Then, the reinforcing bar portion not covered with the concrete was immersed once in a 10% NaCl aqueous solution. The chloride ion concentration of the concrete 40a was 5 kg/m³.

Subsequently, the reinforcing bar portion not covered with concrete was dried. Then, as illustrated in FIG. 3B, a repairing agent containing a resin and a nitrate-type layered double hydroxide was directly applied to the portion of the reinforcing bar 20a not covered with the concrete 40a and a joint surface 41 of the concrete.

Subsequently, as illustrated in FIG. 3C, the portion coated with the repairing agent (reinforcing bar 20a, joint surface 41) was covered with a polymer cement mortar 14a. Thereafter, curing was performed in a constant temperature chamber at a temperature of 23° C. and a humidity of 60% for two and a half years.

Thereafter, as illustrated in FIG. 3D, the reinforcing bar 20a was chipped out, and a crystalline compound generated in the reinforcing bar portion coated with the repairing agent was estimated using an X-ray diffractometer.

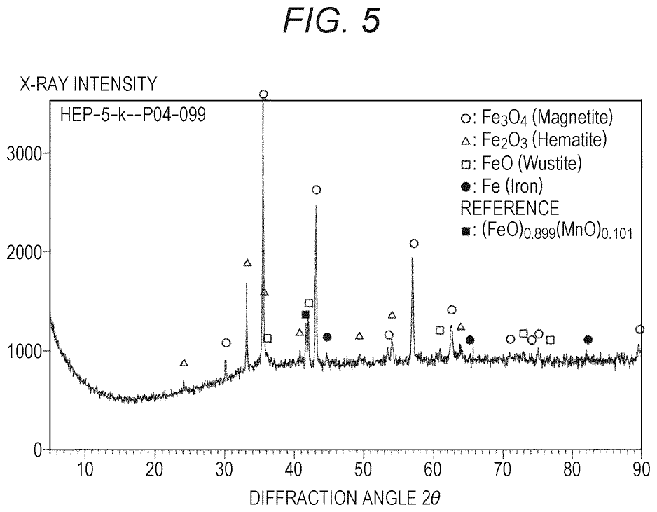

FIG. 5 illustrates the results of X-ray diffraction obtained with the X-ray diffractometer. In FIG. 5, the horizontal axis represents the diffraction angle 20 (deg), and the vertical axis represents the X-ray intensity. From FIG. 5, it was found that magnetite (Fe₃O₄) was present in addition to Fe₂O₃, FeO, and Fe in the reinforcing bar portion coated with the repairing agent. That is, the present experiment demonstrated that the reaction of the above reaction formula (1) occurred in the reinforcing bar portion coated with the repairing agent.

As described above in detail, according to the present embodiment, when a reinforcing bar to which salt (chloride ion) adheres is subjected to a rust prevention treatment, a repairing agent containing a resin and a nitrate-type layered double hydroxide is directly applied. As a result, the nitrate-type layered double hydroxide applied to the reinforcing bar adsorbs chloride ions and releases nitrate ions, so that magnetite (Fe₃O₄), that is, black rust is generated on the surface of the reinforcing bar as in the above reaction formula (1). As a result, red rust is not generated on black rust, so that occurrence of corrosion in the reinforcing bar can be effectively prevented. Here, conventionally known rust inhibitors include a rust inhibitor of an aqueous solution containing nitrite ions. Such an aqueous solution containing nitrite ions has a risk of exposure to the human body and environmental load. On the other hand, in the case of the repairing agent of the present embodiment, although the repairing agent contains nitrate ions, the nitrate ions are fixed to the layered double hydroxide (solid) before application to a reinforcing bar. As a result, nitrate ions are released to the outside of the layered double hydroxide for the first time under an environment where chloride ions exist, and thus there is little risk of exposure to the human body or environmental load.

In addition, in the present embodiment, because the repairing agent contains a resin, a place where the repairing agent is applied can be made into an anaerobic environment and an environment with as little H₂O as possible. Thereby, the reaction of the above reaction formula (1) can be further promoted.

In addition, a conventionally known rust inhibitor sometimes uses a cementitious material as a binder material, but in the case of a rust inhibitor containing such a cementitious material, a treatment of repairing a cross section using a polymer cement mortar (see FIG. 1D) cannot be performed unless curing is performed for, for example, 16 hours or more after application. This is because the polymer cement mortar cannot be applied when the cementitious material is in a semi-dry state. On the other hand, use of a resin as the binder material as in the present embodiment enables application of the polymer cement mortar even when the resin is in a semi-dry state (during a period between when the repairing agent starts to cure and when the repairing agent cures completely). Therefore, it is possible to perform the treatment of repairing the cross section using the polymer cement mortar (see FIG. 1D) in a short time (for example, in about one hour) after the repairing agent is applied. Accordingly, the rust prevention work can be efficiently performed in a short time.

In the above embodiments, a case where a repairing agent containing a resin and a nitrate-type layered double hydroxide is applied to a reinforcing bar to perform a rust prevention treatment has been described. However, the present invention is not limited thereto. The repairing agent may be applied to a steel material other than the reinforcing bar to perform a rust prevention treatment. For example, when a nitrate-type layered double hydroxide is added to a coating material having a low viscosity, the nitrate-type layered double hydroxide may not be distributed evenly and may accumulate at the bottom. Therefore, it is preferable to provide a stirring step before the repairing agent of the present embodiment is used. In addition, it is preferable to stir the repairing agent even when the resin or the coating material is mixed with the nitrate-type layered double hydroxide at the repair site. By this stirring step, the amount of the nitrate-type layered double hydroxide used can be reduced, and the production cost of the repairing agent can be reduced. Note that, regardless of the viscosity of the repairing agent, the above-described stirring step may be performed before the repairing agent is used.

As an example, it is preferable that the nitrate-type layered double hydroxide is contained in an amount of 1% to 10%, preferably 1% to 5% in weight ratio with respect to the resin or the coating material. This is because when the content of the nitrate-type layered double hydroxide is small, the rust prevention effect or the effect of preventing neutralization of concrete is weakened, and when the content of the nitrate-type layered double hydroxide is large, the production cost of the repairing agent increases.

The above-described embodiments are preferred examples of the present invention. However, the present invention is not limited thereto, and various modifications can be made without departing from the scope of the present invention.

The following is a list of reference signs used in this specification and in the drawings.
10 Concrete structure
20 Reinforcing bar (steel material)
14 Polymer cement mortar
31 Temporary fixing seal material
32 Injection place
33 Injection tool

1. A repair method for a reinforced concrete, comprising:
injecting a repairing agent containing a layered double hydroxide represented by a chemical formula M²⁺₁₋ₓM³⁺ₓ(OH)₂(NO₃⁻)_{x/n}·mH₂O into a concrete from a void on a surface of reinforced the concrete, wherein M²⁺ represents a divalent metal, M³⁺ represents a trivalent metal, and n is a natural number; and
applying the repairing agent containing the layered double hydroxide to the concrete.

2. The repair method for the reinforced concrete according to claim 1, comprising:
applying the repairing agent containing the layered double hydroxide to a reinforcing bar exposed by chipping the concrete.

3. The repair method for the reinforced concrete according to claim 1, wherein a resin is contained in the repairing agent containing the layered double hydroxide.

4. The repair method for the reinforced concrete according to claim 2, comprising:
covering the reinforcing bar with a concrete material during a period between when the repairing agent starts to cure and when the repairing agent cures completely.

5. The repair method for the reinforced concrete according to claim 4, wherein:
a resin is contained in the repairing agent containing the layered double hydroxide,
the resin is a thermosetting resin, and
a time from when the repairing agent is applied to the reinforcing bar to when the reinforcing bar is covered with the concrete material varies depending on a temperature around the reinforcing bar.

6. The repair method for the reinforced concrete according to claim 2, wherein chloride ions are adsorbed by the layered double hydroxide to form black rust on a surface of the reinforcing bar.

7. The repair method for the reinforced concrete according to claim 4, comprising:
drying a surface of the reinforcing bar.

8. The repair method for the reinforced concrete according to claim 4, wherein:
a resin is contained in the repairing agent containing the layered double hydroxide, and the method comprises:
forming an anaerobic environment on a surface of the reinforcing bar by applying the resin to the surface of the reinforcing bar.

9. The repair method for the reinforced concrete according to claim 4, wherein:
a resin is contained in the repairing agent containing the layered double hydroxide, and the method comprises:
forming an anaerobic environment on the surface of the reinforcing bar by applying the resin to the surface of the reinforcing bar.

10. The repair method for the reinforced concrete according to claim 7, wherein at least one of carbon dioxide inside the concrete or carbon dioxide on a surface of the concrete is adsorbed by the layered double hydroxide.
